(19) United States
(12) Patent Application Publication
(10) Pub. No.: US 2022/0138786 A1
(43) Pub. Date: May 5, 2022

(54) ARTIFICIAL INTELLIGENCE (AI) PRODUCT INCLUDING IMPROVED AUTOMATED DEMAND LEARNING MODULE

(71) Applicant: International Business Machines Corporation, New York, NY (US)

(72) Inventors: Kunal Sawarkar, Franklin Park, NJ (US); Aaron Lee, Austin, TX (US); Vinodh Mohan, Manchester, CT (US); Samuel Clyde Kenneth Rooney, New York, NY (US)

(21) Appl. No.: 17/088,515

(22) Filed: Nov. 3, 2020

(51) Int. Cl. G06Q 30/02; H04L 12/911

(52) U.S. Cl. CPC G06Q 30/0206; H04L 47/788

(57) ABSTRACT

A network computing apparatus configured to perform an automated resource allocation method including obtaining price-demand data for a product, macro-clustering the price-demand data to identify a plurality of product categories, building a plurality of demand curves corresponding to the product categories, micro-clustering the demand curves to find a refined set of demand curves for each of the product categories, selecting one of the refined set of demand curves based on a difference between a predicted demand and an observed demand, selecting a price for the product according to the selected one of the demand curves, and allocating a resource according to the selected one of the demand curves corresponding to the pricing data generated, wherein the macro-clustering is performed using a first hyperparameter and the micro-clustering is performed using a second hyperparameter.

### BACKGROUND

The present disclosure relates generally to a machine learning, and more particularly to automated demand prediction for discrete and unknown continuous spaces.

Demand learning is a domain in the field of machine learning. Conventional demand prediction is performed based on historical analysis methods, such as forecasting, planning or regression methods. Historic data is not available in all cases. Lack of historical data can be a challenge for known problems when prior history is not available, but also for novel problems.

Existing practices for predicting demand for a product estimate the demand of that product at a given price given robust historic data throughout an entire range of prices. Typically, a demand curve for a product reveals that demand decreases as price increases, when for example, customers who were willing to buy a product at $20 find the product too costly at $22. The reduction in demand may decrease revenue for the company. It may also be possible that the reduction in demand is small enough to be compensated for by increased revenue that the $2 increase in price generated. In other words, overall revenue and profit can increase despite a reduction in demand.

The task of demand prediction is a fundamental challenge in the pricing market. Conventionally, demand learning assumes that it is impossible to find real demand without prior knowledge.

### SUMMARY

According to some embodiments of the present invention, a network computing apparatus configured to perform an automated resource allocation method including obtaining price-demand data for a product, macro-clustering the price-demand data to identify a plurality of product categories, building a plurality of demand curves corresponding to the product categories, micro-clustering the demand curves to find a refined set of demand curves for each of the product categories, selecting one of the refined set of demand curves based on a difference between a predicted demand and an observed demand, selecting a price for the product according to the selected one of the demand curves, and allocating a resource according to the selected one of the demand curves corresponding to the pricing data generated, wherein the macro-clustering is performed using a first hyperparameter and the micro-clustering is performed using a second hyperparameter.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments may provide for:

automatically learning parameters of a demand learning pipeline;

demand learning for dynamic pricing and resource allocation for a continuous space of services domain with limited or not experimental data;

determination of a number meta-clustering demand curves for demand learning that optimizes price and resource allocation; and

automatic learning and tuning of parameters of a demand system.

These and other features and advantages of the present invention will become apparent from the following detailed description of illustrative embodiments thereof, which is to be read in connection with the accompanying drawings.

### BRIEF DESCRIPTION OF THE DRAWINGS

Preferred embodiments of the present invention will be described below in more detail, with reference to the accompanying drawings:

FIG. 1 depicts a cloud computing environment according to an embodiment of the present invention;

FIG. 2 depicts abstraction model layers according to an embodiment of the present invention;

FIG. 3 is an illustration of a method for demand learning according to an embodiment of the present invention;

FIG. 4 is an illustration of a method for demand learning according to an embodiment of the present invention;

FIG. 5 is a graph showing a plurality of demand curves according to an embodiment of the present invention;

FIG. 6 is a graph of a slope and initial price of the demand curves according to an embodiment of the present invention;

FIG. 7 shows a k-means clustering of the points of FIG. 6 according to an embodiment of the present invention;

FIG. 8 shows a selection of the demand curves from FIG. 5 according to an embodiment of the present invention;

FIG. 9 shows a graph of error averaged for all records in a testing set and plotted to choose a k value according to an embodiment of the present invention;

FIG. 10 shows dynamic pricing graphs according to an embodiment of the present invention;

FIG. 11 shows a gradient decent method automatically changing parameters of the dynamic pricing to minimize error according to an embodiment of the present invention;

FIG. 12 shows curves calculated to a non-linear demand curve according to an embodiment of the present invention;

FIG. 13 is a graph of the demand curves for each discrete price point according to an embodiment of the present invention;

FIG. 14 shows a spectral clustering of different non-liner curves according to an embodiment of the present invention; and

FIG. 15 depicts a computer system that may be useful in implementing one or more aspects and/or elements of the invention.

### DETAILED DESCRIPTION

According to some embodiments, a learning method is described that reduces lost opportunity using less historic information and more rapidly than conventional methods. Lost opportunity is a difference between a predicted variable and an optimal variable.

It should be understood that the variable of interest can include, but is not limited to, price of a product or service. For example, embodiments of the present invention extend to additional variables for scaling (or sizing) of distributed compute resource (processes/systems/memory), managing software subscriptions, predicting unknown demand in a system for a variable with respect to economic stress, etc. Embodiments of the present invention enable accurate responses to (potentially unforeseen) disturbances in demand for various products or services. Example disturbances can include natural phenomenon, widespread health emergences, humanitarian crises, etc.

One problem with conventional demand learning methods is that conventional methods are designed for the retail domain with a discrete product space. Conventional methods do not work for continuous spaces like subscription services. This is because there are limited or no supply side constraints or inventory management problems for continuous spaces, such as in the case of ecommerce retailors providing subscription services.

Embodiments of the present invention overcome another limitation of the conventional methods where a human is required to provide a demand hypotheses and target prices for those demand hypotheses. Furthermore, the number of demand hypotheses can be difficult to determined, as too many demand curves result in overfitting, while too few demand curves may not provide enough data. There is currently no mechanism to automatically tune a demand learning model to provide a correct number of demand hypotheses.

Embodiments of the present invention are well suited to implementation in conjunction with the Automated Artificial Intelligence (AutoAI) product for IBM Watson AI under Cloud Pak for Data. For example, a demand learning module according to one or more embodiments of the present invention can be incorporated (e.g., inherited, loaded, etc.) by an Artificial Intelligence (AI) product to improve the capabilities of the AI.

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

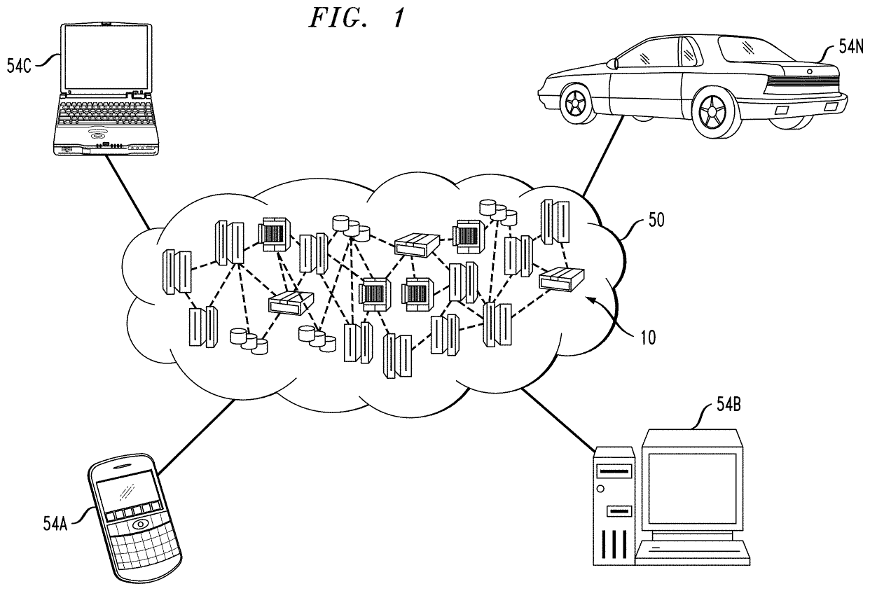

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

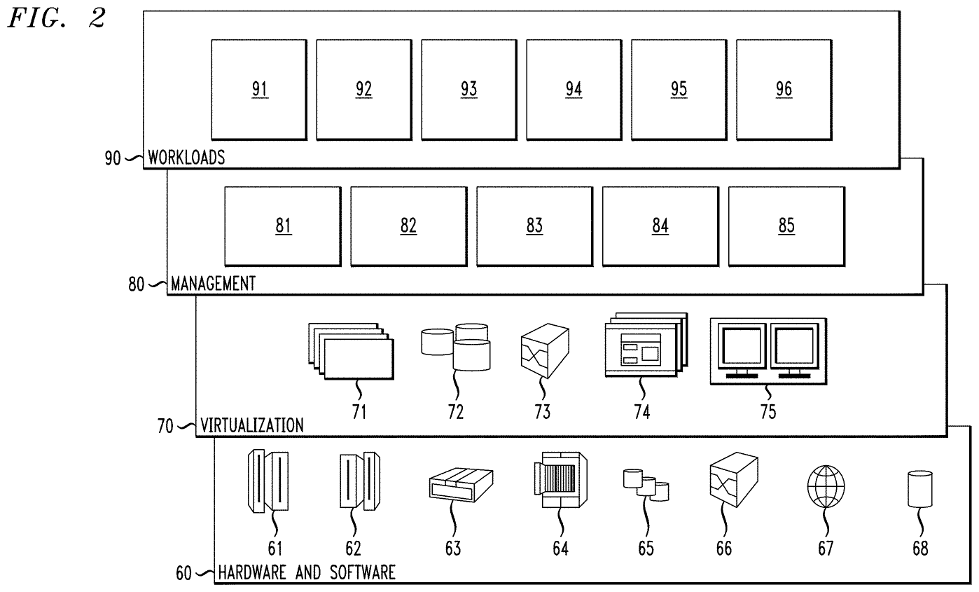

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and automatically learning parameters of a demand learning pipeline for setting a price and an allocation of an associated resource 96.

Embodiments of the present application enable an end-to-end system configured to perform unsupervised dynamic pricing and resource allocation. Methods can be implemented in an AutoAI type solution. Embodiments of the present application include methods applicable and automatically adjustable to various demand problems (e.g., for discrete demand produce spaces and for unknown continuous service spaces). Embodiments for full support for automated hyperparameter tuning, automated parameter tuning (including the number of meta clusters, level of data aggregation, etc.), model training and validation are described.

Reinforcement learning according to some embodiments of the present invention enables direct learning from real world phenomenon as they occur. According to some embodiments, a method is applicable to dynamic pricing and resource allocation problems, and can also generate dynamic demand curves based on demand conditions (like induced economic vulnerability due to unforeseeable disturbances).

According to some embodiments, automated hyperparameter tuning includes adjusting an aggregation level in the data to increase (e.g., maximize) a result (e.g., revenue, resource utilization, etc.). Embodiments of the present invention work with linear and non-linear demand curves. Embodiments of the present invention do not require historical data (i.e., historical data for particular values of the variable of interest), and can initiate a demand learning method using only experimental data determined after initialization of the demand learning with a set of hypotheses and an initial price.

It should be understood, in the context of one or more embodiments of the present invention that sufficient historical data may not be available, or if available not usable. For example, in the case of a novel market event that upsets demand, previous years' demand data may be available, but will not be particularly useful to predict future demand in the new market regime (e.g., as in the case of markets upset by a pandemic). In another exemplary case, historic demand data will not be available for a new product. According to some embodiments of the present invention, demand can be predicted with a small amount of data, which would be insufficient for convention machine learning methods; methods according to embodiments of the present invention generate improved models based on a given (e.g., small) amount of data.

In an exemplary implementation, available historic data does not include a given value of a variable of interest (e.g., demand for a service—requiring compute cycles, nodes, etc. —in a new market, e.g., for a new geographic area in which pricing data is not available). In the case where the service was not previously offered in the market, the historic demand data it will not be available. Embodiments of the present invention will output a demand prediction for the missing data point(s), enabling improved pricing and resource allocation. Given the demand prediction at a selected price, the output can include a specific allocation of a resource (e.g., compute cycles, physical nodes, etc.), to support the demand prediction (resource application can be determined directly from the demand prediction corresponding to the selected price). As described above, embodiments of the present invention are extensible to various implementations, including for example, pricing, allocation of resources (e.g., a number of server nodes, compute cycles, memory recourses, etc.), management of licensing subscriptions, etc.

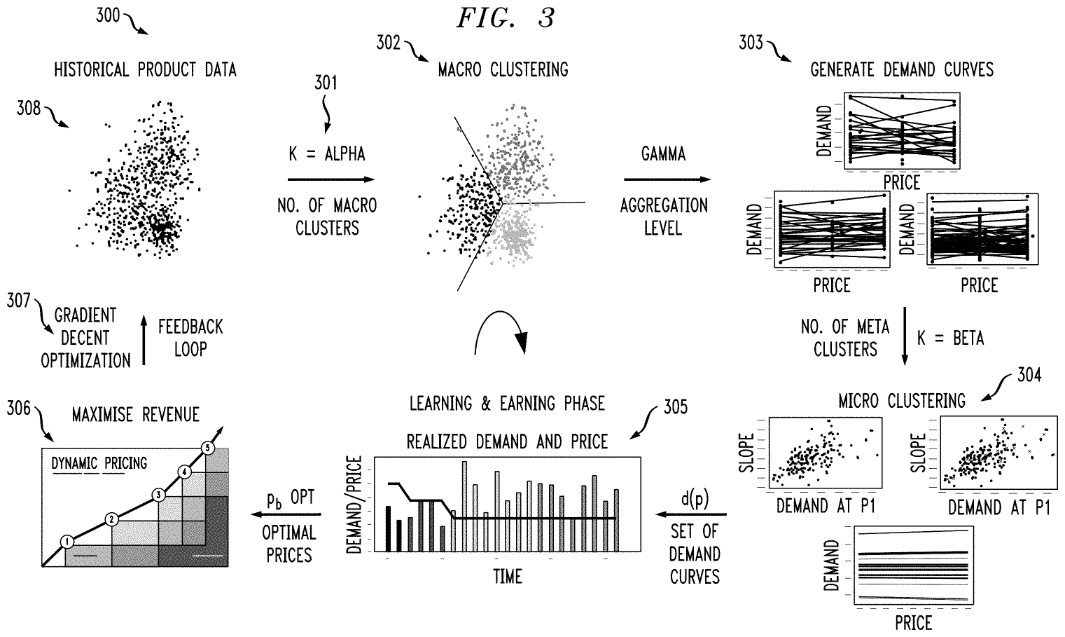

FIG. 3 is an overview of a demand prediction method 300 performed for linear demand curves according to an embodiment of the present invention. The demand prediction method 300 uses a k-means clustering method for macro clustering 302 using k=alpha, and for micro clustering 304 using k=beta, where alpha and beta are hyperparameters that maximize that a variable of interest. The k-means clustering is a method of vector quantization that aims to partition data into k clusters in which each observation belongs to a cluster with a nearest mean (cluster centers or cluster centroid), serving as a prototype of the cluster.

According to FIG. 3 a macro-customer segmentation model is created 301 for k=alpha (a), which segments the (potentially incomplete) continuous data space into a number of macro clusters. According to some embodiments, the segmentation can be by value in terms of demand, revenue/profit, etc. According to some embodiments, the historical product data 308 may include data points for a variety of products, such that the macro-clustering 301/302 segments the data into product categories. In the case of predicting demand for a new product, the product data 308 does not initially include any data points corresponding to the new product. In the case of a service, the macro-clustering 301/302 segments the data into categories according to different discovered demand behaviors (e.g., the behavior of business customers of the service and the behavior of leisure customers of the service). According to one or more embodiments, a price sensitivity index is determined 302 for every macro cluster of the data space given k=alpha. At 302 the macro-clusters are ranked by the price sensitivity index and the space is discretized as different categories. The method includes building a set of the initial demand curves 303 based on the historical price change data for each k=alpha clusters. Herein, it should be understood that demand curves are substantially interchangeable with demand functions, wherein the demand curves are the embodiments (e.g., depictions) of underlying demand functions. For each k=alpha, the demand curves are mapped to a plane, and a micro-clustering is created with centroids k=beta (β) 304. A target (e.g., optimal) price is calculated for the given combination of k (alpha, beta) and its maximum revenue at each segment level 305 (each combination of demand and price, segmented by product/service category). The method projects the overall maximum revenue for k (alpha, beta) and logs it as a point statistic 306. The method uses (alpha, beta) as hyperparameters (a configuration that is external to the model and whose value cannot be estimated from data) and tunes the hyperparameters over a number of iterations to find a final target price 307. According to at least one embodiment, the tuning 307 is performed as a coordinate decent optimization, a Results-Based Financing (RBF) calculation, or some other optimization method at each iteration. Further, at 307, a resource allocation is determined and implemented given the predicted demand at the selected price at each iteration. That is, some embodiments of the present invention include allocation of a resource in support of the selected price.

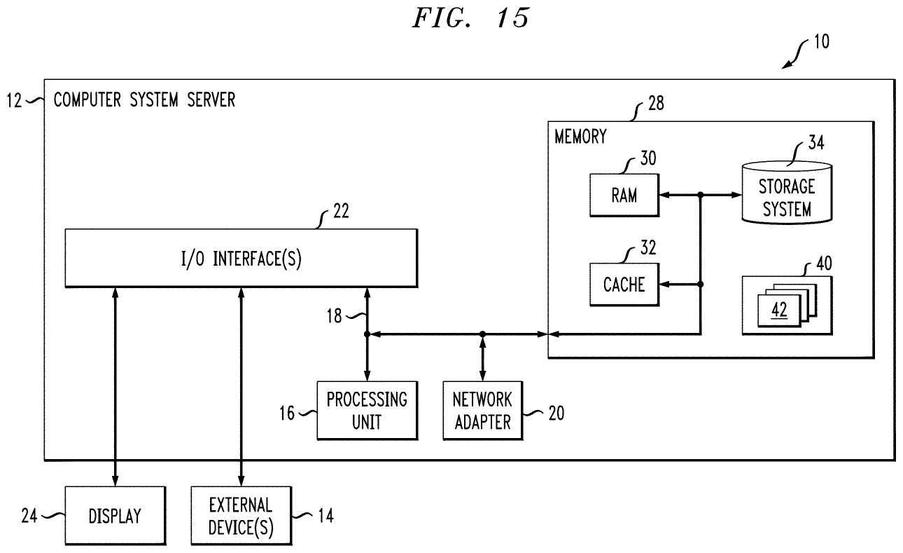

According to some embodiments, the demand prediction method 300 can be implemented for non-linear demand curves/non-linear demand functions, where a beta and gamma distribution (described herein) are plotted for different curves at 303/403, and spectral clustering (see FIG. 14) is used at 304/404 to group the various curves together.

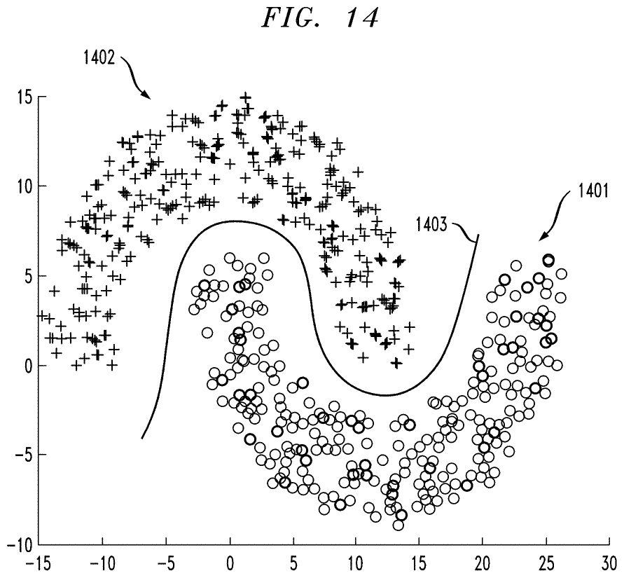

More particularly, for non-linear curves, a predisposed distribution (e.g., a gamma distribution—a two-parameter family of continuous probability distributions—or a beta distribution—continuous probability distributions defined on the interval [0, 1] parameterized by two positive shape parameters, denoted by alpha (α) and beta (β), that appear as exponents of the random variable and control the shape of the distribution—) is assumed (see FIG. 13). The points are fitted to the non-linear curve (e.g., gamma distribution or beta distribution), which has conjugate priors. The curve is mapped to a two-dimensional space using two points of conjugate priors (e.g., gamma-gamma distribution or beta-binomials distribution). The points in two-dimensional space are clustered using a database (DB) scan clustering method or the like. The meta-clustering can be performed using a conventional density based clustering method to calculate a threshold epsilon for clusters (a value that defines a maximum distance between two points in a cluster). According to some embodiments, using epsilon as a hyperparameter along with alpha, the method tunes the demand learning model for the optimal price and resource allocation.

In the context of non-linear demand curves and spectral clustering, it should be understood that two points are considered neighbors in a cluster if the distance between the two points is below the threshold epsilon. The method of density clustering also finds a minimum value of epsilon, ensuring a correct number of clusters is determined. For example, a value for epsilon can be calculated as a distance to the nearest n points for each point, sorting and plotting the distances, where a largest change between points (e.g., a critical change in the curves) is selected as epsilon. According to one or more embodiments, the determined number of clusters is calculated to maximize a desired metric, such as a variable of interest (e.g., revenue, profit, efficiency, or any variable defined with respect to demand).

According to some embodiments, meta-reinforcement learning/support-vector machine (SVM) techniques can be used to find a reward (e.g., a maximum reward) for revenue.

According to at least one embodiment, a layer of aggregation of time (time of day/day/weekly/monthly) is used as an additional hyperparameter.

According to one embodiment, it can be assumed that the method 300 can be implementable when there are at least two sets of discrete price and demand values for each product or service are defined. These sets of values are the initial historical product data 308, which may be insufficient for conventional demand prediction. Some embodiments of the present invention obtain experimental data throughout a range of potential prices. Here, a product can mean a retail product that has different sets of experimented prices and observed demands, or a service such as subscription service, which has at least two discrete sets of price and demand variables. Different products within a same space (retail, subscription, etc.) can have different demand curves and in this context some embodiments include classifying/identifying product categories that include a number of products. A real-time experimentation can be used for learning the demand dynamically during a learning phase in order to minimize the lost opportunity and maximize the revenue in an exploitation phase (which can further include finding an optimal resource allocation).

According to some embodiments, at block 401, macro clustering is used to identify different product categories. In a space where segmenting products into different categories is not straight-forward, e.g., as in an established retail space, unsupervised clustering can be used to create (artificial) product categories. For example, a product such as a Wi-Fi subscription in the airline industry does not have any explicit categories, such as in the retail industry where products can be categorized as, for example, electronics, food, beauty, personal care etc. According to embodiments of the present invention, unsupervised clustering is used to categorize the subscription products based on resulting clusters, which have unique features between them. The input features for the unsupervised clustering can include the demographics of the customers using the products, characteristics of the product, time-based aggregate features, etc.

According to some embodiments, the clustering identifies different product categories, which each have different demand curves, and are to be treated separately for the demand learning process. The objective of macro-clustering 401 is to discover a pattern (e.g., of behavior) in the available data.

According to some embodiments, the target attributes can be included in the unsupervised clustering. These target attributes are hints to the clustering method on how to perform the clustering. To achieve improved results, data is clustered by all attributes, and then the clusters can be analyzed by an attribute of interest.

According to at least one embodiment, a feature of interest such as demand, price, and revenue of the products, is omitted from the unsupervised clustering.

The macro clustering 401 method includes using historical product data and its features as input variables for a clustering method. According to some embodiments, different clustering algorithms (e.g., k-means, k-modes, and k-prototypes) can be implemented, and a best among them is chosen based on a measure of how well each algorithm performs. According to some embodiments, the number of clusters (k) is identified based on the inter-cluster vs. intra-cluster separation distances using, for example, a DB-index, Silhouette scores, etc. According to at least one embodiment, the demand, revenue, and profit distribution for each cluster is visualized and the different demand curve patterns are verified. Additionally, price elasticity of demand is observed for each cluster by calculating a price sensitivity index (e.g., degree to which price affects the demand for a product or service.).

According to some embodiment, the product categories for demand learning are defined as follows: each cluster is considered as a product category (e.g., having distinct demand range, characteristics); and clusters having close characteristics are combined/split based on the price sensitivity index. In the macro-clustering method 401, closeness can be measured by various distance metrics, such as an Euclidian distance, hamming distance, Manhattan distance, etc.

Referring to block 402, the method builds demand hypothesis functions/curves from the (limited) historical data 308. According to some embodiments, the method for dynamic pricing using demand learning is applied to each product category separately, and a resulting solution is unique for each category 302. For each product category, the method builds a finite set of demand curves 303 using the available, limited, historical product data, e.g., the price and demand. Using historical data helps in generating demand curves that are close to a true demand function.

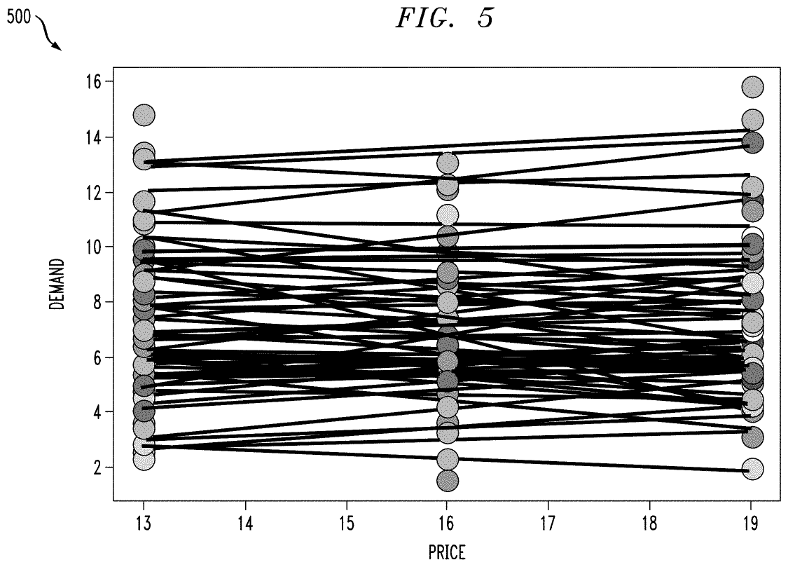

According to some embodiments, the historical data 308 is split into training set and a testing set using a split ratio of, for example, 80:20. According to some embodiments, with at the minimum two price and demand pairs (pi,di) available, a linear demand function is fit using a least squares method used in the regression technique for each product data in the training set. This generates N number of demand curves 500 of the form d(p)=a+bp, where p is price and d(p) is demand as a function of price (see FIG. 5).

It should be understood that a price and demand pair (pi,di) includes data based on available historical data points. According to at least one embodiment, the price and demand pairs (pi,di) do not include the price of interest. For example, the hypothesis demand function/curve is based on prices that are either used in the past or user defined. This is an initiation point, technically an approximation for a model to initialize demand learning.

Referring to block 403, micro-clustering (or meta-clustering) 304 refines a set of demand curves for each product category. Based on the limited volume of historical data available, the number of demand curves(N) for a product category can be large. Also, the N curves generated are an absolute representation of the historical data (e.g., a limited representation) in a space that could be closer to the true demand space. Micro clustering of the N demand curves (also called meta clustering) refines and reduces these finite set of demand curves to a few representative curves. This reduced set of curves facilitate learning, ensures that the methods does not overfit, and produces an improved convergence close to a true demand curve.

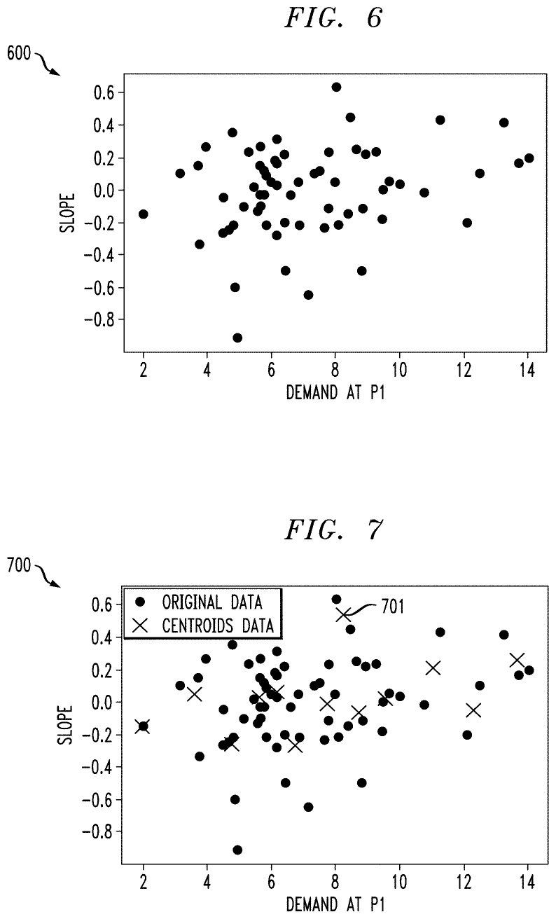

According to some embodiments, for the micro-clustering 304, each linear demand function from 303 is mapped to a point on a plane such as the y-coordinate is the slope of the demand curve and x-coordinate is the demand function d(p1)=a+bp1, where p1 is the initial price (see 600, FIG. 6). An initial price can be a random price or a price that is to be used for a future product for which the demand learning is required. According to some embodiments, k-means clustering is applied to group these points into k clusters. The k centroid points (xi,yi) (e.g., 701), or the centers of each cluster, represent a linear demand function in the demand space (see 700, FIG. 7). These k centroid points are converted into k demand functions, such as d(p)=xi+yi (p1+p) (see 800, FIG. 8).

According to some embodiments, to choose a set of final demand curves that represent the product category, the method attempts to choose an ideal number of k centroid points or clusters for the algorithm. A k-fold cross validation technique can be used to find the ideal k value, and for that purpose the testing set is used in calculating the average of total errors for each k value chosen and selecting the k with minimum average error value as per the following steps.

According to at least one embodiment, for each data point in the testing set (having at least two price and demand pairs (pi,di)), a hypothesis demand function/curve is selected from the k demand functions/curves based on minimum [predicted demand ˜observed demand] for the initial price p1.

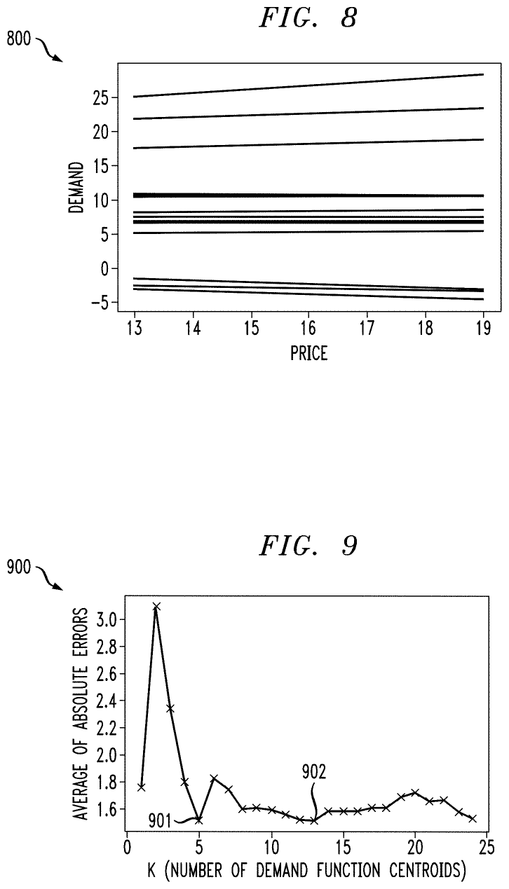

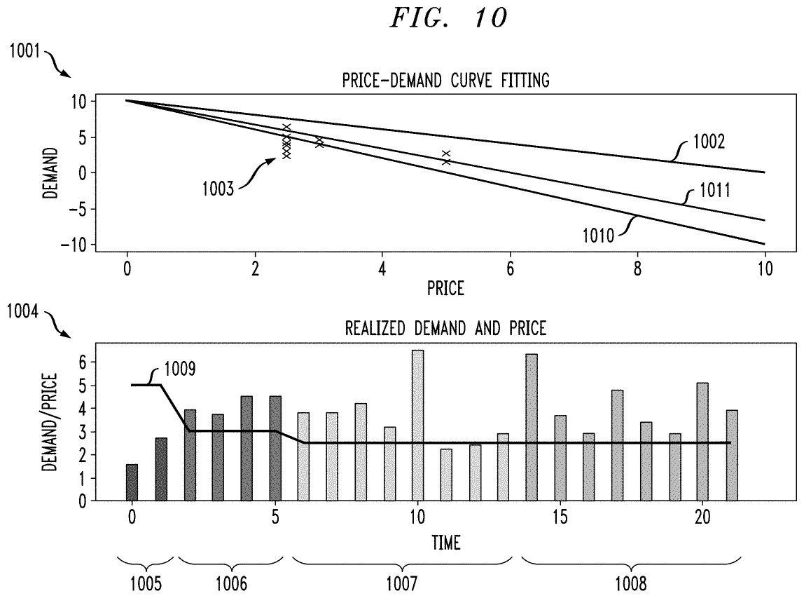

Using the chosen hypothesis demand function/curve, a difference [predicted demand observed demand] at price P2 is determined as an error of the learning method. The error is averaged for all records in the testing set and plotted to select a k value. The selected k value is the one that has a minimum average error value (see 900, FIG. 9). As shown in FIG. 9, k=5 901 and k=13 902 have a minimum average error value. Among values for k having an equal value, according to some embodiments, a lower k is selected (i.e., k=5 901), though either can be used. According to at least one embodiment, the lowest k at a first knee or elbow point is selected (e.g., k=5 901). It should be understood that k is used as the second hyperparameter beta.

Other methods of selecting k can be used. For example, according to at least one embodiment, the value of k is chosen corresponding to a first lowest error value (i.e., the value at a first low knee point), and used to find an optimal price/max revenue. The method then iterates through some subsequent values of k, calculating an optimal price/max revenue for each, and selects from among these values of k, the k having a best respective max revenue.

Referring to block 404, the method includes a learning phase/exploration phase in which optimal prices for each product are generated. According to some embodiments, given the final set of hypothesis demand function/curves for each product category, the method applies dynamic pricing for a new product that may belong to any of the product category. At block 404, the method seeks to generate a price for each learning period (mi) consecutively such that the demand at the price will theoretically maximize the revenue according to:

P*=argmaxₚ p×d(p)

where p=price; d(p)=demand function; P*=revenue−optimal price. This is the learning phase, where the price at which the product sales theoretically maximize revenue is determined.

Referring more particularly to block 404, for a new product, the method identifies the optimal value of the variable of interest. For example, the method identifies an optimal price by initializing with a random initial price p1 for the experimentation phase. According to at least one embodiment, the random initial price p1 is selected within some range established based on business knowledge, the limited historic data, etc. According to some embodiments, the initial value can be random, or a random value selected from within a min-max range defined by a user.

According to some embodiments, the learning phase is configured to run for a learning interval (e.g., 2 to 7 days) selected based on the product definition to identify a predicted optimal price (pb). The predicted optimal price is used in the exploitation phase for some exploitation intervals (e.g., the next 1 to 3 weeks) to generate a maximum revenue.

According to some embodiments, the learning interval and exploitation interval are user defined. For example, in a retail or airline context, a demand behavior varies by week (e.g., people buy more on weekends or travel less on weekend), and the user specifies that the experimental data is collected over a few weeks, with the learning interval spread by couple of days. According to some embodiments, the learning interval is selected to learn demand and capture (or mimic) a current demand behavior. According to some embodiments, the minimum demand cycle (or approximation thereof) is selected as a duration of the exploration phase.

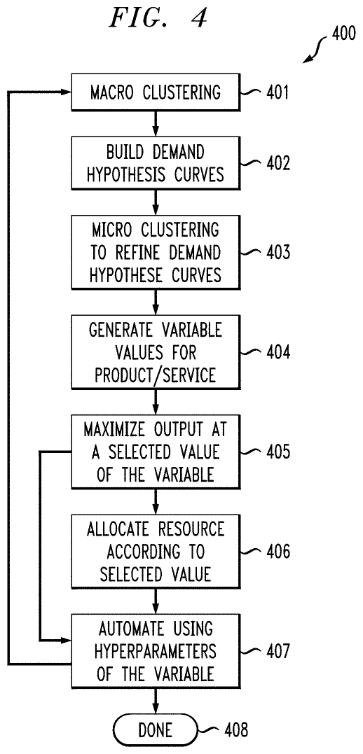

The set of demand hypotheses, the (random) initial value for the variable (e.g., price) and the range of values for the variable (e.g., prices that the product can have) are inputs for the method (e.g., received at block 401, FIG. 4).

Similar to choosing a value of k at block 403, at block 404 for each learning interval (mi) the method picks a demand function/curve from the set of demand hypothesis functions/curves using a minimum [predicted demand—observed demand] at an initial price p 1. The price(pi) (e.g., predicted optimal price) at the end of the learning interval(mi) is calculated for the chosen demand hypothesis using the above revenue equation, and that price (pi) is set as the initial price for a next learning interval (mi+1). At the end of the learning phase, a final price (pb) and a corresponding demand function (d(pb)) are saved. Again, it should be understood that price is an example variable, and that embodiments of the present invention are extensible to other variables.

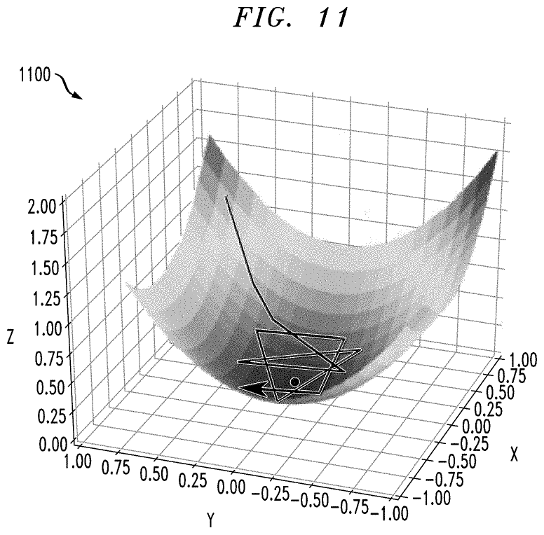

Referring to block 405, the method includes an exploitation phase, which seeks to maximize revenue at the final price (pb). According to some embodiments, the final price (pb) (e.g., best optimal price) is offered for the product throughout the exploitation phase (e.g., 21 days), and that generates actual data about a maximum revenue with a theoretical lost opportunity O(log^{(m)} T), where m is the number of price changes and T is the total experimentation time period (see FIG. 10).

As shown in FIG. 10, the revenue before a price change and after a price change (and potentially after adjusting for time, e.g., seasonality, effects) is determined, and a difference is the maximum reward (R) obtained through the dynamic pricing method. The graph 1001 shows different price-demand curves, e.g., 1002, fit to data points, e.g., 1003, determined from the data collected over time and depicted in graph 1004. For example, curve 1003 corresponds to a latest set of data points (e.g., demand) 1008 determined based for a current price.

In FIG. 10 it can be seen that the price 1009 is adjusted over time, and demand data sets 1005-1008 (shown as bars) are collected. According to some embodiments, the time set for collection of data at each price is variable, with the time being extended for each subsequence price change.

As shown in graph 1001 of observed demand, where each demand curve is fit for a different period of time, where the demand curves become more accurate over time as additional data is collected. For example, curve 1010 is fit to demand data set 1006, curve 1011 is fit to data set 1007, and curve 1002 is fit to data set 1008.

According to one or more embodiments, a resource allocation is selected according to the predicted demand curve 406 (illustrated in graph 1001). For example, a number of servers are automatically configured to provide support to a service being provided according to the predicted demand curve and given a selected price (e.g., pb). In another example, a power generator is controlled to produce an amount of electricity according to the predicted demand curve and given a selected price. According to at least one embodiment, the relationship of demand to resource allocation can be determined according to an SLA. For example, service level management 84 provides cloud computing resource allocation and management such that required service levels, determined as the demand curve 1002, are met. As such, SLA planning and fulfillment 85 provides pre-arrangement for, and procurement of, cloud computing resources for which a future requirement (e.g., the demand curve) is anticipated in accordance with an SLA.

Referring to block 407, the method is automated as an end-to-end pipeline using the hyperparameters, which are tuned through each iteration of the method 400 (see FIG. 4). According to some embodiments, the methodology from macro-clustering 401 to finding the best optimal price (pb) in the exploitation phase 405 and automated allocation of resources 406 is automated and optimized through a feedback loop mechanism, which periodically determines a maximize reward(R). According to at least one embodiment, the hyperparameters (alpha, beta, and gamma) are set for this optimization (where alpha is the shape parameter and beta is the inverse scale parameter, also called a rate parameter).

It should be understood that the k value, or number of macro clusters at block 401, is the first hyperparameter alpha and the k value or the number of micro clusters (centroids—see for example, 701, FIG. 7) chosen at block 404 is the second hyperparameter beta. The level of aggregation used in the data (such as daily, weekly, monthly etc.) to calculate demand for a product is the third hyperparameter gamma (a distribution parameterized in terms of alpha and beta).

By tuning the hyperparameters alpha and beta 307, different sets of demand curves can be provided for each product category and hence different optimal prices and revenue. Tuning the hyperparameter gamma for the level of aggregation can improve an accuracy of the optimal price predictions by canceling out noise (errors). The hyperparameter tuning can be performed using a gradient descent or the like. Hence, the reward (R) can be improved (e.g., maximized) over time and the end-to-end pipeline can be monitored.

According to some embodiments, a method iteratively tunes the hyperparameters of the system 307 until they converge on a (e.g., optimal) solution (output periodically at block 408), enabling the automated hyperparameter tuning.

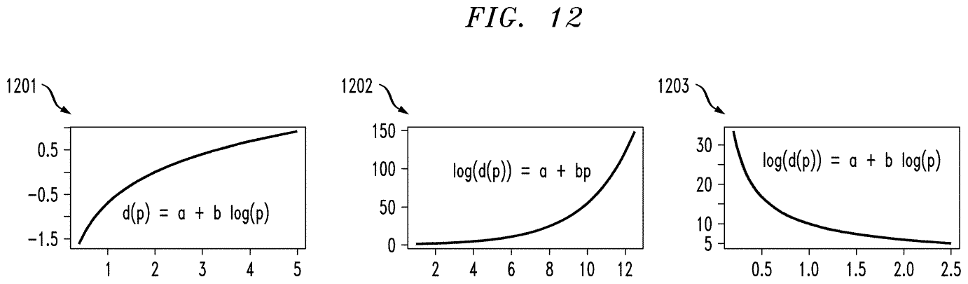

According to some embodiments, a gradient descent method (or its variants) can be used to tune individual parameters of the model (model parameters are configuration variables that are internal to the model and whose value can be estimated from the data such as number of product clusters, number of demand curve clusters, level of aggregation, regularization parameters, etc.), which are changed in increments and a test is performed to determine if the model has become more or less accurate using the changed individual parameters. If the change is a positive one (model becomes more accurate), the algorithm continues to change the parameters in that direction. On the other hand, if the change is negative, gradient descent algorithm shifts the parameters in another direction. In this way, the gradient descent method can be envisioned as moving a ball down a slope until it reaches a lowest point (an area where the model has minimal area). These directions also have a magnitude (e.g., how great a difference the change was whether it was positive or negative). The magnitude directions can be used to describe a geometric surface and are known as gradients. The method attempts to descend to the lowest point along these gradients to reduce (e.g., minimize) model error (see 1100, FIG. 11).

According to some embodiments of the present invention, a gradient descent is used to automatically change the parameters of the demand prediction system to reduce (e.g., minimize) its error. For example, if the method clusters seven product categories, a gradient descent may then try clustering with eight categories. If the eight cluster system performs better than the seven cluster system, gradient descent will move to nine clusters. If nine clusters performs worse, then the method reverts back to eight clusters.

Example embodiment for third hyperparameter for aggregation level: meta-reinforcement learning can use state and action pairs of two levels of hyperparameters and optimize for the policy of maximum reward, which is the maximum revenue.

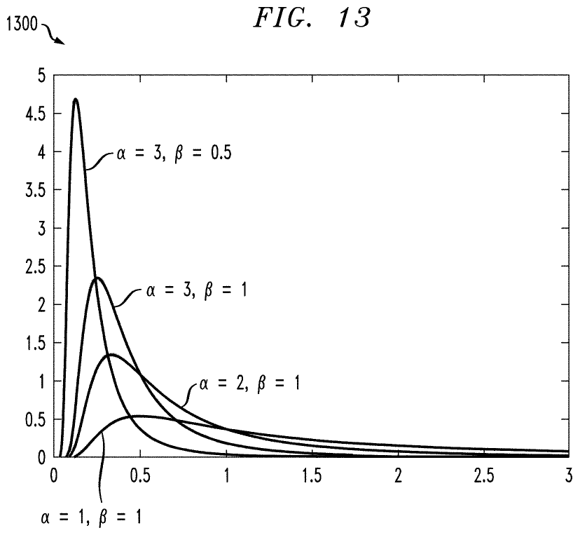

Example embodiment for non-linear demand curves: a set of demand hypothesis can be built from historical data using least squares method in block 402, which yields linear demand functions. The relationship between price and demand is not always linear in nature. Non-linear demand hypothesis or functions can be used to establish the relationship between price and demand. There are several types of non-linear demand curves that can be built that can replace the linear curves used in block 402. For example, according to some embodiments, a log transformation can be used on the price, demand or both, and a non-linear curve of the following forms can be fit, which yield the following curves (see FIG. 12):

d(p)=a+b log(p) (1201)

log(d(p))=a+bp (1202)

log(d(p))=a+b log(p) (1203)

It should be understood that FIG. 12 illustrates the exponential distribution family for a (alpha), b (beta), and p (price).

FIG. 13 shows a graph 1300 of the demand curves for each discrete price point, which is a probability density function. While FIG. 13 shows a gamma distribution for alpha (a) and beta ((3), any form of the exponential distribution family can be used to generate the demand curves for each discrete price points. It should be understood that the gamma distribution is a two-parameter family of continuous probability distributions. The mean value for each of these demand curves represent the average demand at that price point. The alpha and beta parameters are determined for each of these curves. The determined alpha and beta parameters are those that maximize that variable of interest. The method selects the price based on the revenue that best increases (e.g., maximizes) the product of average demand and corresponding price.

Using spectral clustering, different non-liner curves 1401 and 1402 can be grouped together as shown in FIG. 14. The spectral clustering shows clusters of non-linier curves. The images shows a clear line of demarcation 1403 between the curves 1401 and 1402.

According to some embodiments of the present invention, the demand prediction system is integrated into a computer system (e.g., a cloud environment) to facilitate demand learning and automated scaling (or sizing) of distributed resources, such as memory, processors, and/or applications. For example, certain systems/processes can be improved to allocate resources based on a demand prediction, or to account for high usage conditions, which could otherwise lead to system failure or degradation of system performance. According to some embodiments, the demand prediction system learns a prediction for resource demand, and act on the prediction to automatically scale (or size) the compute environment (e.g., adding additional nodes to a cluster).

According to one example case, demand can be predicted for a newly deployed client facing web application with an unknown client usage variable (e.g., bandwidth). In the example case, sufficient server resources are allocated to the web application according to the predicted demand for bandwidth.

According to another example case, a deep learning model is trained on a distributed GPU, which can be scaled according to need. There is a cost associated with having unused resources, and if the system becomes overloaded and loses performance there is direct impact on revenue. According to one or more embodiments, a predicted resource load is used to ensure some minimum threshold level of system performance to prevent system failure.

According to some embodiments of the present invention, an enterprise organization information technology task includes managing software subscriptions, which can be closely related to physical resources in cases where resources are obtained under license (e.g., licensed resources calculated per deice or CPU, per user, per network, per subscription, etc.). Software evolves constantly and most new software has no historical data to gauge demand. According to some embodiments, demand for software licenses can be dynamically predicted based on limited user interactions, such that software subscriptions for an organization can be accurately managed, leading to improved provisioning/allocation of resources under license. For example, predictions about demand for software licenses can be used in procuring a correct amount some physical resource, managing end-of-life support for licenses, etc.

Recapitulation:

According to some embodiments of the present invention, network computing apparatus configured to perform an automated resource allocation method including obtaining price-demand data for a product (308), macro-clustering the price-demand data to identify a plurality of product categories (301/302/401), building a plurality of demand curves corresponding to the product categories (303/402), micro-clustering the demand curves to find a refined set of demand curves for each of the product categories (304/403), selecting one of the refined set of demand curves based on a difference between a predicted demand and an observed demand (305/404), selecting a price for the product according to the selected one of the demand curves (306/405), and allocating a resource according to the selected one of the demand curves corresponding to the pricing data generated (406), wherein the macro-clustering is performed using a first hyperparameter and the micro-clustering is performed using a second hyperparameter.

The methodologies of embodiments of the disclosure may be particularly well-suited for use in an electronic device or alternative system. Accordingly, embodiments of the present invention may take the form of an entirely hardware embodiment or an embodiment combining software and hardware aspects that may all generally be referred to herein as a “processor,” “circuit,” “module” or “system.”

Furthermore, it should be noted that any of the methods described herein can include an additional step of providing a computer system for organizing and servicing resources of the computer system. Further, a computer program product can include a tangible computer-readable recordable storage medium with code adapted to be executed to carry out one or more method steps described herein, including the provision of the system with the distinct software modules.

One or more embodiments of the invention, or elements thereof, can be implemented in the form of an apparatus including a memory and at least one processor that is coupled to the memory and operative to perform exemplary method steps. FIG. 15 depicts a computer system that may be useful in implementing one or more aspects and/or elements of the invention, also representative of a cloud computing node according to an embodiment of the present invention. Referring now to FIG. 15, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 15, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 15, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 15) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 1-2 and accompanying text. Consider, e.g., a database app in layer 66.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

Exemplary System and Article of Manufacture Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A network computing apparatus configured to perform an automated resource allocation comprising:
obtaining price-demand data for a product;
macro-clustering the price-demand data to identify a plurality of product categories;
building a plurality of demand curves corresponding to the product categories;
micro-clustering the demand curves to find a refined set of demand curves for each of the product categories;
selecting one of the refined set of demand curves based on a difference between a predicted demand and an observed demand;
selecting a price for the product according to the selected one of the demand curves; and
allocating a resource according to the selected one of the demand curves corresponding to the pricing data generated,
wherein the macro-clustering is performed using a first hyperparameter and the micro-clustering is performed using a second hyperparameter.

2. The method of claim 1, further comprising obtaining new price-demand data for the product after the selection of the price, and using the new price-demand data, iteratively performing the macro-clustering, building of the demand curves, micro-clustering, selecting one of the refined set of demand curves, selecting the price, and allocating the resource.

3. The method of claim 2, further comprising tuning the first and the second hyperparameters at each iteration according to a coordinate decent optimization.

4. The method of claim 1, wherein the macro-clustering further comprises:
creating a segmentation model to form a macro-cluster of segments of the price-demand data, the macro-cluster comprising a plurality of segments;
calculating a sensitivity index for each of the segments;
ranking the segments using the sensitivity index; and
discretizing the price-demand data as the product categories corresponding to the segments.

5. The method of claim 1, wherein building the plurality of demand curves comprises building a demand curve for each of a number of the product categories determined according to the first hyperparameter.

6. The method of claim 1, wherein the micro-clustering further comprises;
mapping the demand curves to a plane;
creating a micro-clustering of the demand curves with a number of centroids determined by the second hyperparameter; and
converting the centroids into a plurality of demand functions.

7. The method of claim 1, wherein the price is selected for a combination of the first and the second hyperparameters.

8. The method of claim 1, wherein the demand curves are non-linear.

9. The method of claim 8, wherein the micro-clustering comprises performing a spectral clustering of the two-dimensional space using a non-linear distribution for the non-linear demand curves.

10. The method of claim 9, wherein the non-linear distribution is a gamma distribution.

11. A non-transitory computer readable storage medium comprising computer executable instructions which when executed by a computer cause the computer to perform a method for automated resource allocation comprising:
obtaining price-demand data for a product;
macro-clustering the price-demand data to identify a plurality of product categories;
building a plurality of demand curves corresponding to the product categories;
micro-clustering the demand curves to find a refined set of demand curves for each of the product categories;
selecting one of the refined set of demand curves based on a difference between a predicted demand and an observed demand;
selecting a price for the product according to the selected one of the demand curves; and
allocating a resource according to the selected one of the demand curves corresponding to the pricing data generated.

12. The computer readable storage medium of claim 11, wherein the macro-clustering is performed using a first hyperparameter and the micro-clustering is performed using a second hyperparameter.

13. The computer readable storage medium of claim 12, further comprising obtaining new price-demand data for the product after the selection of the price, and using the new price-demand data, iteratively performing the macro-clustering, building of the demand curves, micro-clustering, selecting one of the refined set of demand curves, selecting the price, and allocating the resource.

14. The computer readable storage medium of claim 13, further comprising tuning the first and the second hyperparameters at each iteration according to a coordinate decent optimization.

15. The computer readable storage medium of claim 11, wherein the macro-clustering further comprises:
creating a segmentation model to form a macro-cluster of segments of the price-demand data, the macro-cluster comprising a plurality of segments;
calculating a sensitivity index for each of the segments;
ranking the segments using the sensitivity index; and
discretizing the price-demand data as the product categories corresponding to the segments.

16. The computer readable storage medium of claim 11, wherein building the plurality of demand curves comprises building a demand curve for each of a number of the product categories determined according to the first hyperparameter.

17. The computer readable storage medium of claim 11, wherein the micro-clustering further comprises;
mapping the demand curves to a plane;
creating a micro-clustering of the demand curves with a number of centroids determined by the second hyperparameter; and
converting the centroids into a plurality of demand functions.

18. The computer readable storage medium of claim 11, wherein the price is selected for a combination of the first and the second hyperparameters.

19. The computer readable storage medium of claim 11, wherein the micro-clustering comprises performing a spectral clustering of the two-dimensional space using a non-linear distribution for the non-linear demand curves.

20. The computer readable storage medium of claim 19, wherein the non-linear distribution is a gamma distribution.
